(19) United States
(12) Patent Application Publication
(10) Pub. No.: US 2023/0404274 A1
(43) Pub. Date: Dec. 21, 2023

(54) Foldable Bunk Bed Device for a Toy Hauler Trailer

(71) Applicants: Alan Mosher, Kernersville, NC (US); Lucas Derr, Murrells Inlet, SC (US)

(72) Inventors: Alan Mosher, Kernersville, NC (US); Lucas Derr, Murrells Inlet, SC (US)

(21) Appl. No.: 17/868,029

(22) Filed: Jul. 19, 2022

Related U.S. Application Data
(60) Provisional application No. 63/354,037, filed on Jun. 21, 2022.

(51) Int. Cl. A47C 19/20; A47C 19/12; B60P 3/34

(52) U.S. Cl. CPC A47C 19/202; A47C 19/128; B60P 3/34

(57) ABSTRACT

The present invention relates generally to the field of bunk beds. More specifically, the present invention relates to a foldable bunk bed device for a toy hauler trailer that is primarily comprised of at least one bunk frame attached to at least one vertical frame member and at least one motor. The device is designed to be used within the garage area of a toy hauler trailer. The bunk frame can be raised upward within the garage area when not in use or lowered down into the garage area when in use. The bunk frame attaches to a track within the vertical frame member, wherein the track may be powered by a motor which can be controlled by a remote. The bunk frame may further have an additional support leg and a ladder. The bunk frame receives a mattress that allows a user to sleep.

### CROSS-REFERENCE TO RELATED APPLICATION

The present application claims priority to, and the benefit of, U.S. Provisional Application No. 63/354,037, which was filed on Jun. 21, 2022, and is incorporated herein by reference in its entirety.

### FIELD OF THE INVENTION

The present invention relates generally to the field of bunk beds. More specifically, the present invention relates to a foldable bunk bed device for toy hauler trailers that is primarily comprised of at least one bunk frame attached to at least one vertical frame member and at least one motor. The device is designed to be used within the garage area of a toy hauler trailer. The bunk frame can be raised upward within the garage area when not in use or lowered down into the garage area when in use. The bunk frame attaches to a track within the vertical frame member, wherein the track may be powered by a motor which can be controlled by a remote. The bunk frame may further have an additional support leg and a ladder. The bunk frame receives a mattress that allows a user to sleep. Accordingly, the present disclosure makes specific reference thereto. Nonetheless, it is to be appreciated that aspects of the present invention are also equally applicable to other like applications, devices, and methods of manufacture.

### BACKGROUND

A toy hauler can be a travel trailer, fifth-wheel trailer, or even a motorhome. The back of a toy hauler trailer typically has a garage area that allows a user to store vehicles such as, but not limited to: motorcycles, ATVs, UTVs, etc. The garage area is further comprised of a ramp door to allow for the loading and unloading of said vehicles. However, when said vehicles are unloaded from the toy hauler, a large amount of empty space is then present within the garage area. This empty space is often unused. In addition, many toy haulers often lack adequate space to house a plurality of individuals. As a result, individuals may be forced to camp outside in tents, which are susceptible to severe weather.

Therefore, there exists a long-felt need in the art for a device that can be used within a garage area of a toy hauler trailer. Further, there exists a long-felt need in the art for a foldable bunk bed device for a toy hauler trailer, wherein the device provides a place for multiple individuals to sleep within the toy hauler trailer. In addition, there exists a long-felt need in the art for a foldable bunk bed device for a toy hauler trailer, wherein the device provides a place for multiple individuals to sleep within the toy hauler trailer and wherein the device does not inhibit the storage ability of the garage area when the device is not in use.

The subject matter disclosed and claimed herein, in one embodiment thereof, comprises a foldable bunk bed device for toy hauler trailers. The device is primarily comprised of at least one bunk frame attached to at least one vertical frame member and at least one motor. The device is designed to be used within the garage area of a toy hauler trailer, wherein the bunk frame can be raised upward within the garage area when not in use or lowered down into the garage area when in use. The bunk frame attaches to a track within the vertical frame member, wherein the track may be powered by a motor which can be controlled by a remote. The bunk frame may further have an additional support leg and a ladder. The bunk frame receives a mattress that allows a user to sleep.

In this manner, the foldable bunk bed device for toy hauler trailers of the present invention accomplishes all of the foregoing objectives and provides a device that can be used within a garage area of a toy hauler trailer to provide a place for multiple individuals to sleep within the toy hauler trailer. In addition, the device does not inhibit the storage ability of the garage area when the device is not in use. Therefore, the device is extremely advantageous and practical.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a foldable bunk bed device for toy hauler trailers. The device is primarily comprised of at least one horizontal bunk frame attached to at least one vertical frame member and at least one motor. The device is preferably manufactured from a durable metal and is designed to be used within the garage area of a toy hauler trailer. In the preferred embodiment of the device, the vertical frame members are removably fastened to the surfaces of the garage area via at least one fastener. In the preferred embodiment, the device also has four bunk frames attached to the vertical frame members.

Each bunk frame is further comprised of a floor that supports a mattress. The mattress may be any mattress type known in the art. The mattress may also be any mattress size known in the art. In various embodiments, the floor may be a plurality of metal wires that form a plurality of grids or a solid piece of metal or other material.

The bunk frame attaches to a track located within each vertical frame member, wherein the track can move vertically within the frame member such that the bunk frame can be raised upward when not in use or lowered downward when in use. In one embodiment, the track is powered by at least one motor, further comprised of at least one battery and at least one receiver.

The motor can be operated by a plurality of buttons located on the motor that allows a user to activate the motor to move the track upward and downward within the frame member such that the bunk frame can be raised and lowered as needed during use/storage. In a differing embodiment, at least one receiver of the motor communicates with at least one transmitter of at least one remote that allows a user to activate the motor to move the track upward and downward such that the bunk frame can be raised and lowered as needed.

In addition to being supported by the vertical frame member, the bunk frame is further supported by at least one leg that may be fixedly attached to the frame and is immovable. In another embodiment, the leg is attached to the frame via at least one hinge that allows the leg to fold for storage when the device is not in use. The bunk frame is further comprised of at least one ladder which allows a user to easily climb into the bunk frame.

In one embodiment, the frame is further comprised of a pouch that may be comprised of at least one fastener such as, but not limited to: hook and loop, magnet, snap button, etc., that allows the pouch to securely close. In this manner, a user can store valuables within the pouch (i.e., a cell phone) while sleeping on the mattress.

Accordingly, the foldable bunk bed device for toy hauler trailers of the present invention is particularly advantageous as it provides a device that can be used within a garage area of a toy hauler trailer to provide a place for multiple individuals to sleep within the toy hauler trailer. Further, the device does not inhibit the storage ability of the garage area when the device is not in use. In this manner, the foldable bunk bed device for toy hauler trailers provides a novel and practical solution to increasing the functionality of a toy hauler trailer.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a foldable bunk bed device for toy hauler trailers of the present invention installed and lowered in a garage area of a toy hauler trailer in accordance with the disclosed architecture;

FIG. 2 illustrates a perspective view of one potential embodiment of a foldable bunk bed device for toy hauler trailers of the present invention installed and lowered in a garage area of a toy hauler trailer without a mattress in accordance with the disclosed architecture;

FIG. 3 illustrates a perspective view of one potential embodiment of a foldable bunk bed device for toy hauler trailers of the present invention installed and lowered in a garage area of a toy hauler trailer while partially collapsed in accordance with the disclosed architecture; and

FIG. 4 illustrates a perspective view of one potential embodiment of a foldable bunk bed device for toy hauler trailers of the present invention installed and raised in a garage area of a toy hauler trailer above a vehicle in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can be used within a garage area of a toy hauler trailer. Further, there exists a long-felt need in the art for a foldable bunk bed device for a toy hauler trailer, wherein the device provides a place for multiple individuals to sleep within the toy hauler trailer. In addition, there exists a long-felt need in the art for a foldable bunk bed device for a toy hauler trailer, wherein the device provides a place for multiple individuals to sleep within the toy hauler trailer and wherein the device does not inhibit the storage ability of the garage area when the device is not in use.

The present invention, in one exemplary embodiment, is comprised of a foldable bunk bed device for toy hauler trailers primarily comprised of at least one horizontal bunk frame attached to at least one vertical frame member and at least one motor. The device is preferably manufactured from a durable metal and is designed to be used within the garage area of a toy hauler trailer. In the preferred embodiment of the device, the vertical frame members are removably fastened to the surfaces of the garage area via at least one fastener. In the preferred embodiment, the device also has four bunk frames attached to the vertical frame members, wherein each bunk frame is further comprised of a floor that supports a mattress. The mattress may be any mattress type known in the art. The mattress may also be any mattress size known in the art. In various embodiments, the floor may be a plurality of metal wires that form a plurality of grids or a solid piece of metal or other material.

The bunk frame attaches to a track located within each vertical frame member, wherein the track can move vertically within the frame member such that the bunk frame can be raised upward when not in use or lowered downward when in use. In one embodiment, the track is powered by at least one motor, further comprised of at least one battery and at least one receiver.

The motor can be operated by a plurality of buttons located on the motor that allows a user to activate the motor to move the track upward and downward within the frame member such that the bunk frame can be raised and lowered as needed during use/storage. In a differing embodiment, at least one receiver of the motor communicates with at least one transmitter of at least one remote that allows a user to activate the motor to move the track upward and downward such that the bunk frame can be raised and lowered as needed.

In addition to being supported by the vertical frame member, the bunk frame is further supported by at least one leg that may be fixedly attached to the frame and is immovable. In another embodiment, the leg is attached to the frame via at least one hinge that allows the leg to fold for storage when the device is not in use. The bunk frame is further comprised of at least one ladder which allows a user to easily climb into the bunk frame.

The frame may be further comprised of a pouch that may be comprised of at least one fastener such as, but not limited to: hook and loop, magnet, snap button, etc., that allows the pouch to securely close. In this manner, a user can store valuables within the pouch (i.e., a cell phone) while sleeping on the mattress.

Accordingly, the foldable bunk bed device for toy hauler trailers of the present invention is particularly advantageous as it provides a device that can be used within a garage area of a toy hauler trailer to provide a place for multiple individuals to sleep within the toy hauler trailer. Further, the device does not inhibit the storage ability of the garage area when the device is not in use. In this manner, the foldable bunk bed device for toy hauler trailers provides a novel and practical solution to increasing the functionality of a toy hauler trailer.

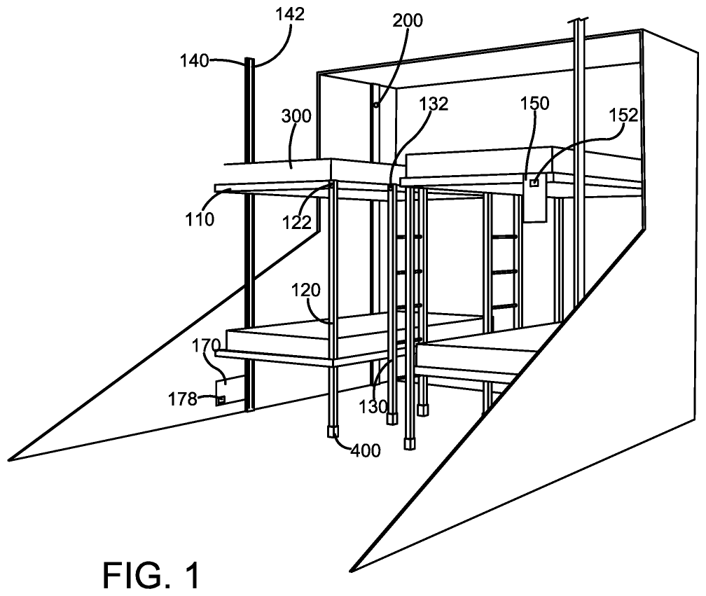

Referring initially to the drawings, FIG. 1 illustrates a perspective view of one potential embodiment of a foldable bunk bed device for toy hauler trailers 100 of the present invention installed and lowered in a garage area 10 of a toy hauler trailer in accordance with the disclosed architecture. The device 100 is primarily comprised of at least one horizontal bunk frame 110 attached to at least one vertical frame member 140 and at least one motor 170. The device 100 is preferably manufactured from a durable metal such as, but not limited to, stainless steel or aluminum in a cylindrical or square shape.

The device 100 is designed to be used within the garage area 10 of a toy hauler trailer. In the preferred embodiment the device 100, the vertical frame members 140 are removably fastened to the surfaces of the garage area 10 (i.e., ceiling, walls, floor, etc.) via at least one fastener such as, but not limited to: a bolt, a bolt and nut assembly, a bolt/nut/washer assembly, etc. In the preferred embodiment, the device 100 has four bunk frames 110. However, differing embodiments of the device 100 may have any number of bunk frames 110 that exceeds zero bunk frames 110.

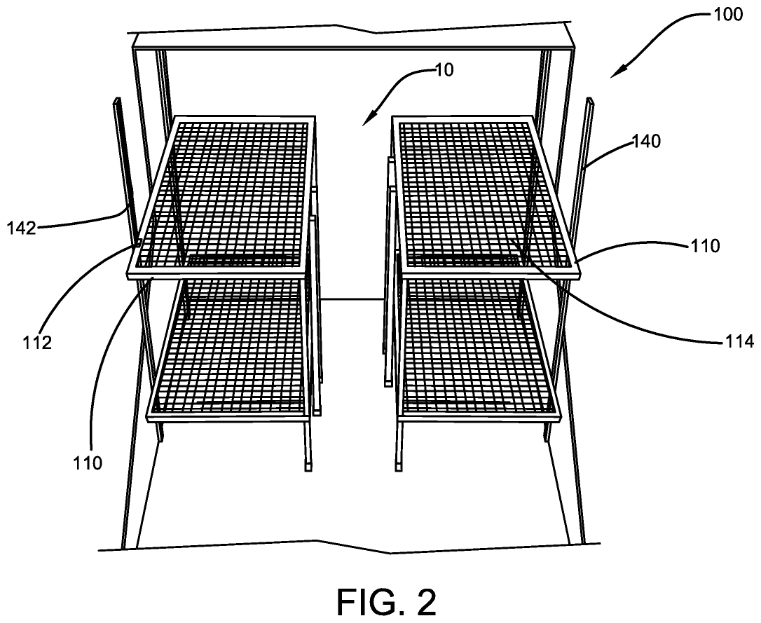

The bunk frame 110 is further comprised of a floor 114 which supports a mattress 300, as seen in FIG. 2. The mattress 300 may be any mattress type known in the art such as, but not limited to: memory foam, innerspring, hybrid, latex, adjustable air, etc. The mattress 300 may also be any mattress size known in the art, wherein the size of the frame 110 accommodates the size of the mattress 300. Mattress sizes include, but are not limited to: Twin, Twin XL, Full, Full XL, King, Queen, California King, etc.

In various embodiments, the floor 114 may be a plurality of metal wires that form a plurality of grids or a solid piece of metal or other material. The bunk frame 110 attaches to a track 142 located within each vertical frame member 140. The track 142 can move vertically within the frame member 140 such that the bunk frame 110 can be raised upward when not in use (to allow a vehicle 12 to be stored within the garage 10) or lowered downward when in use. In one embodiment, the bunk frame 110 may be fixedly connected to the tracks 142 of at least two vertical frame members 140. In another embodiment, the bunk frame 110 may be removably attached to the tracks 142 via at least one fastener 112 such as, but not limited to: a bolt, a bolt and nut assembly, a bolt/nut/washer assembly, a hinge, etc.

In one embodiment, the track 142 is powered by (and receives an electrical power current from) at least one motor 170, such that the track 142 moves within the vertical frame member 140 in a vertical fashion. The motor 170 is preferably located on one vertical frame member 140. The motor 170 is further comprised of at least one battery 172 and at least one receiver 174. The battery 172 may be a disposable battery 172 or a rechargeable battery 172 in the form of an alkaline, nickel-cadmium, nickel-metal hydride battery 172, etc., such as any 3V-12 volts DC battery 172 or other conventional battery 172, such as A, AA, AAA, etc., that supply power to the device 100. Throughout this specification the terms “battery” and “batteries” may be used interchangeably to refer to one or more wet or dry cells or batteries 172 of cells in which chemical energy is converted into electricity and used as a source of DC power. References to recharging or replacing batteries 172 may refer to recharging or replacing individual cells, individual batteries 172 of cells, or a package of multiple battery cells as is appropriate for any given battery 172 technology that may be used. The motor 170 may further have at least one 110 v/240v or USB power outlet 178 to allow devices and items to be charged/powered by the motor 170 and/or motor battery 172.

In one embodiment, the motor 170 can be operated by a plurality of buttons 176 located on the motor 170. Said buttons 176 may allow a user to activate the motor to move the track 142 upward and downward within the frame member 140 such that the bunk frame 110 can be raised and lowered as needed during use/storage. The buttons 176 may also allow the motor 170 to be turned on/off. However, in one embodiment the track 142 is not motorized and can be manually moved by lifting or lowering the bunk frame 110 by hand.

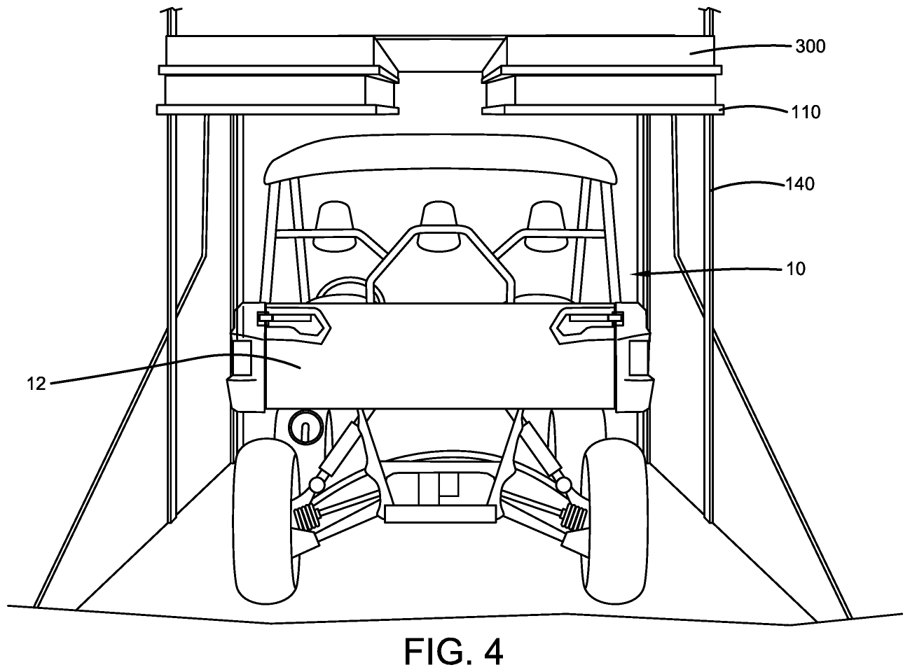

In a differing embodiment, at least one receiver 174 of the motor 170 communicates with at least one transmitter 166 of at least one remote 160. The remote 160 is powered by at least one battery 164 and is further comprised of a plurality of buttons 162 that may allow a user to activate the motor to move the track 142 upward and downward such that the bunk frame 110 can be raised (as seen in FIG. 4) and lowered as needed. The buttons 162 may also allow the motor 170 to be turned on/off. The remote 160 may further have at least one fastener 168, such as, but not limited to: a magnet, a clip, hook and loop, etc., that allows the remote 160 to attach to the bunk frame 110 when not in use.

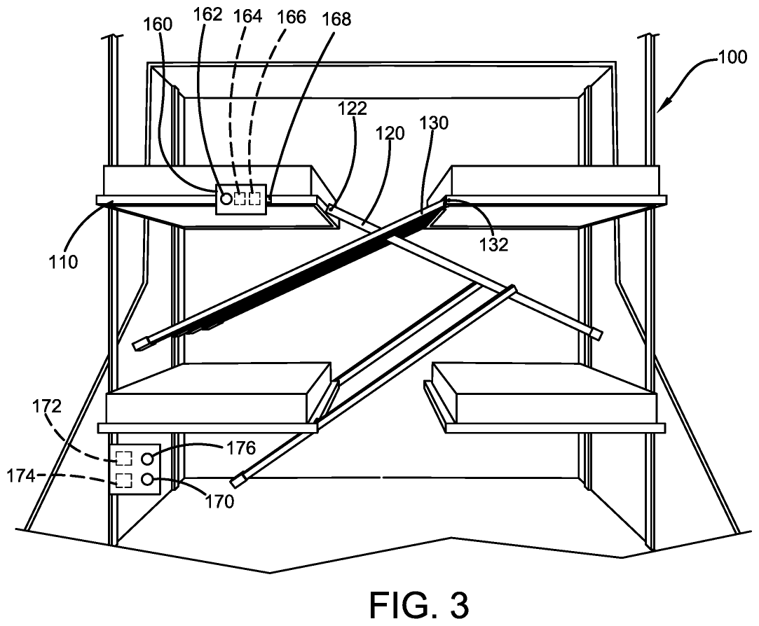

In addition to being supported by the vertical frame member 140, the bunk frame 110 is further supported by at least one leg 120. In one embodiment, the leg 120 is fixedly attached to the frame 110 and is immovable. In another embodiment, the leg 120 is attached to the frame 110 via at least one hinge 122. The hinge 122 allows the leg 120 to fold for storage when the device 100 is not in use. The leg 120 preferably folds underneath or above the bunk frame 110, as seen in FIG. 3. The leg 120 may further be telescopic and collapsible to aid in storing the device 100 within a garage area 10 when not in use.

The bunk frame 110 is further comprised of at least one ladder 130. The ladder 130 allows a user to easily climb into the bunk frame 110. In an embodiment of the device 100 with four bunk frames 110, and wherein two frames 110 are positioned directly above two frames 110, only the upper frames 110 have said ladder 130. In one embodiment, the ladder 130 is fixedly attached to the frame 110 and is immovable. In another embodiment, the ladder 130 is attached to the frame 110 via at least one hinge 132. The hinge 132 allows the leg 132 for storage when the device 100 is not in use. The ladder 132 preferably folds underneath or above the bunk frame 110, as seen in FIG. 3. In one embodiment, the ladder 130 is a rope ladder. The ladder 130 may further be telescopic and collapsible to aid in storing the device 100 within a garage area 10 when not in use. The leg 120 and ladder 130 may further be comprised of at least one rubber foot 400 that covers the portion of the leg 120 and ladder 130 that contacts the floor of the garage area 10 to protect the floor against scratch/scrape damage.

In one embodiment, the frame 110 is further comprised of a pouch 150. The pouch 150 may be comprised of at least one fastener 152 such as, but not limited to: hook and loop, magnet, snap button, etc., that allows the pouch 150 to securely close. In this manner, a user can store valuables within the pouch 150 (i.e., a cell phone) while sleeping on the mattress 300.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “foldable bunk bed device for toy hauler trailers” and “device” are interchangeable and refer to the foldable bunk bed device for toy hauler trailers 100 of the present invention.

Notwithstanding the forgoing, the foldable bunk bed device for toy hauler trailers 100 of the present invention and its various components can be of any suitable size and configuration as is known in the art without affecting the overall concept of the invention, provided that they accomplish the above-stated objectives. One of ordinary skill in the art will appreciate that the size, configuration, and material of the foldable bunk bed device for toy hauler trailers 100 as shown in the FIGS. are for illustrative purposes only, and that many other sizes and shapes of the foldable bunk bed device for toy hauler trailers 100 are well within the scope of the present disclosure. Although the dimensions of the foldable bunk bed device for toy hauler trailers 100 are important design parameters for user convenience, the foldable bunk bed device for toy hauler trailers 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A foldable bunk bed device for a toy hauler trailer, the foldable bunk bed device comprising:
a bunk frame;
a vertical frame member comprised of a track;
a ladder; and
a leg.

2. The foldable bunk bed device for a toy hauler trailer of claim 1, wherein the ladder attaches to the bunk frame via a hinge.

3. The foldable bunk bed device for a toy hauler trailer of claim 1, wherein the leg attaches to the bunk frame via a hinge.

4. The foldable bunk bed device for a toy hauler trailer of claim 1, wherein the bunk frame attaches to the track.

5. A foldable bunk bed device for a toy hauler trailer, the foldable bunk bed device comprising:
a bunk frame;
a vertical frame member comprised of a track;
a ladder;
a leg;
a motor;
a battery; and
a plurality of controls.

6. The foldable bunk bed device for a toy hauler trailer of claim 5, wherein the leg and the ladder attach to the bunk frame.

7. The foldable bunk bed device for a toy hauler trailer of claim 6, wherein the bunk frame attaches to the track.

8. The foldable bunk bed device for a toy hauler trailer of claim 7, wherein the motor supplies a power to the track.

9. The foldable bunk bed device for a toy hauler trailer of claim 8, wherein the motor causes the track to move vertically within the vertical frame member.

10. The foldable bunk bed device for a toy hauler trailer of claim 9, wherein the plurality of controls control a movement of the track.

11. A foldable bunk bed device for a toy hauler trailer, the foldable bunk bed device comprising:
a vertical frame member comprised of a track;
a bunk frame attached to the track;
a ladder;
a leg;
a remote control comprised of a plurality of controls, a transmitter and a battery; and
a motor comprised of a battery, a transmitter and a plurality of controls.

12. The foldable bunk bed device for a toy hauler trailer of claim 11, wherein the motor causes the track to move vertically within the vertical frame member.

13. The foldable bunk bed device for toy hauler trailers of claim 12, wherein the transmitter of the remote control is in communication with the transmitter of the motor.

14. The foldable bunk bed device for a toy hauler trailer of claim 13, wherein the plurality of controls of the remote control controls a function of the motor.

15. The foldable bunk bed device for a toy hauler trailer of claim 11, wherein the ladder is a rope ladder.

16. The foldable bunk bed device for a toy hauler trailer of claim 11, wherein the leg is a telescopic leg.

17. The foldable bunk bed device for a toy hauler trailer of claim 11, wherein the leg is comprised of a rubber foot.

18. The foldable bunk bed device for a toy hauler trailer of claim 11, wherein the remote control further comprises a fastener.

19. The foldable bunk bed device for a toy hauler trailer of claim 18, wherein the fastener is a magnet.

20. The foldable bunk bed device for a toy hauler trailer of claim 11, wherein the motor is attached to the vertical frame member.
